(19) United States
(12) Patent Application Publication
(10) Pub. No.: US 2022/0279124 A1
(43) Pub. Date: Sep. 1, 2022

(54) IMAGE PROCESSING METHOD, ELECTRONIC DEVICE, AND STORAGE MEDIUM

(71) Applicant: REALME CHONGQING MOBILE TELECOMMUNICATIONS CORP., LTD., Chongqing (CN)

(72) Inventor: Xiaoyang Huang, Chongqing (CN)

(21) Appl. No.: 17/750,005

(22) Filed: May 20, 2022

Related U.S. Application Data
(63) Continuation of application No. PCT/CN2020/127605, filed on Nov. 9, 2020.

(30) Foreign Application Priority Data
Nov. 20, 2019 (CN) 201911144463.4

(51) Int. Cl. H04N 5/232; H04N 5/265; G06T 5/00; G06T 5/50; G06T 3/40; H04N 5/247

(52) U.S. Cl. CPC H04N 5/23267; H04N 5/265; G06T 5/002; G06T 5/50; G06T 5/006; G06T 3/40; H04N 5/247; G06T 2207/20221; G06T 2207/20132

(57) ABSTRACT

Provided are an image processing method, an electronic device, and a non-transitory computer-readable storage medium. The method includes the follows. A first image captured by a first camera and a second image captured by a second camera are obtained respectively, the first camera and the second camera having different field of view. A fused image is generated based on the first image and the second image. An output image is obtained by performing image shake correction on the fused image.

### CROSS REFERENCE APPLICATIONS

This application is a continuation of International Application Number PCT/CN2020/127605, filed on Nov. 9, 2020, which claims the priority of a Chinese patent application with Application Number 201911144463.4, filed on Nov. 20, 2019, the entireties of which are hereby incorporated by reference.

### TECHNICAL FIELD

The present disclosure relates to the technical field of image processing, and particularly to an image processing method, an electronic device, and a non-transitory computer-readable storage medium.

### BACKGROUND

During the video shooting process, the video capture device usually shakes to a certain degree, which causes the recorded video image to be unstable and affects the video shooting effect. At present, the effect of video anti-shake can be achieved through image anti-shake technology. However, the use of such conventional image anti-shake technology results in a reduction in the clarity and frame size of the image.

It should be noted that the information disclosed in this part is just for the purpose of facilitating understanding of the background of the disclosure, and therefore may contain information not belonging to the prior art that is already known to those of ordinary skill in the art.

### SUMMARY

The present disclosure provides an image processing method, an electronic device, and a non-transitory computer-readable storage medium, which overcomes problems caused by the limitations and defects of the related art, such as the reduction in the sharpness and frame size of the image when performing the image shake correction.

According to the first aspect of the present disclosure, an image processing method is provided, which includes the following. A first image captured by a first camera and a second image captured by a second camera are obtained, wherein the first camera and the second camera have different fields of view. A fused image is generated based on the first image and the second image. An output image is obtained by performing image shake correction on the fused image.

According to the second aspect of the present disclosure, an electronic device is provided, which includes a first camera, a second camera, a processor, and a memory. The first camera is configured to capture a first image. The second camera is configured to capture a second image. The memory is configured to store executable instructions for the processor, wherein, the processor is configured to execute the executable instructions to: obtain a first image captured by a first camera and a second image captured by a second camera, wherein the first camera and the second camera have different fields of view; generate a fused image based on the first image and the second image; and generate an output image by performing image shake correction on the fused image.

According to the third aspect of the present disclosure, a non-transitory computer-readable storage medium is provided, on which instructions are stored such that the instructions, when executed by the processor, cause the processor to: obtain a first image captured by a first camera and a second image captured by a second camera, wherein the first camera has a larger field of view than the second camera and the second camera has a higher resolution than the first camera; generate a fused image based on the first image and the second image; and generate an output image by performing image shake correction on the fused image.

It should be understood that the foregoing general description and the following detailed description are exemplary and explanatory only, and are not restrictive of the present disclosure.

### BRIEF DESCRIPTION OF THE DRAWINGS

The drawings, which are incorporated in and constitute a part of this specification, illustrate embodiments of the disclosure and serve to explain the principles of the disclosure together with the specification. Obviously, the drawings in the following description illustrate only some embodiments of the present disclosure. For those of ordinary skill in the art, other drawings can also be obtained from these drawings without creative effort.

FIG. 1 illustrates a schematic diagram of the cropped image in the image plane when the camera is still and the camera is rotated.

FIG. 2 illustrates a flowchart of an image processing method according to an embodiment of the present disclosure.

FIG. 3 illustrates the schematic diagram of calibration checkerboard.

FIG. 4 illustrates a flowchart of a method for generating a fused image in an embodiment of the present disclosure.

FIG. 5 illustrates the schematic diagram of the splicing area of the third image and the second image.

FIG. 6 illustrates a schematic structural diagram of an image processing apparatus according to an embodiment of the present disclosure.

FIG. 7 illustrates a schematic structural diagram of a computer system suitable for implementing an electronic device of an embodiment of the present disclosure.

### DETAILED DESCRIPTION OF PREFERRED EMBODIMENTS

Exemplary embodiments will now be described more comprehensively with reference to the drawings. The exemplary embodiments, however, can be embodied in various forms and should not be construed as limiting examples set forth herein. Rather, these embodiments are provided to make this disclosure thorough and complete, and will fully convey the concept of the exemplary embodiments to those skilled in the art. The described features, structures, or characteristics may be combined in any suitable manner in one or more embodiments. In the following description, numerous specific details are provided in order to give a thorough understanding of the embodiments of the present disclosure. However, those skilled in the art will appreciate that the technical solutions of the present disclosure may be practiced without one or more of the specific details, or be practiced with other methods, components, devices, steps, etc. In other instances, well-known solutions have not been shown or described in detail to avoid obscuring aspects of the present disclosure.

Furthermore, the drawings are merely schematic illustrations of the present disclosure and are not necessarily drawn to scale. The same reference numerals in the drawings denote the same or similar parts, and thus their repeated descriptions will be omitted. Some of the blocks shown in the figures are functional entities that do not necessarily correspond to physically or logically separate entities. These functional entities may be implemented in software, or in one or more hardware modules or integrated circuits, or in different networks and/or processor devices and/or microcontroller devices.

Conventional image anti-shake technology includes optical image stabilization algorithms and electronic image stabilization algorithms. Optical image stabilization algorithms are typically used in high-end cameras or terminal equipment due to the complex design structure and high cost. Electronic image stabilization algorithms, widely used in terminal equipment, do not require additional device structure designs, and only need to cooperate with a gyroscope resident in terminal equipment to achieve better video anti-shake performance.

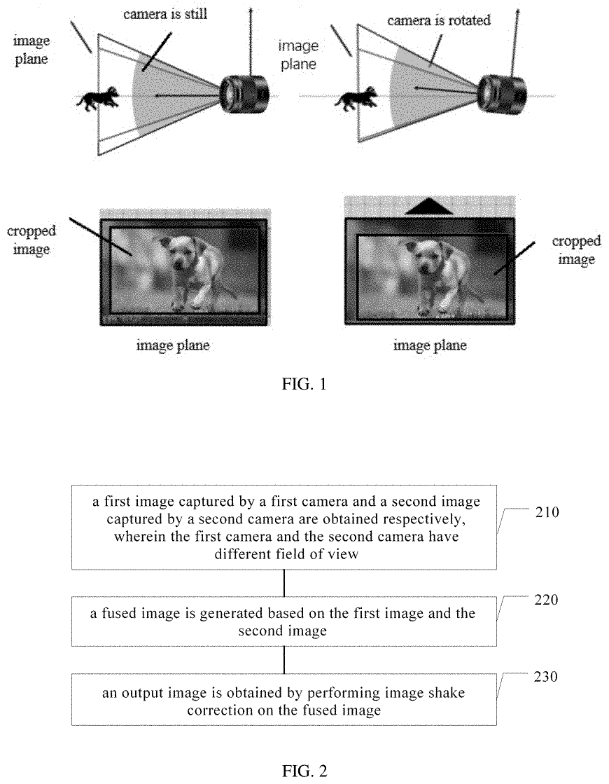

For example, by using an electronic image stabilization algorithm, the angular motion velocity of the three axes of a video capture device can be detected in real time by the gyroscope. Reverse compensation is performed by setting the edge cropping area, so that the picture pixels are stabilized within a certain range, and the image stabilization effect can be achieved. FIG. 1 illustrates a schematic diagram of a cropped image in the image plane when the camera is still and when the camera is rotated. The larger the preset cropping area, the smaller the cropped image and the stronger the anti-shake capability/performance. However, it also leads to lower image clarity and smaller frame size.

In order to solve the problems of reduced image clarity and reduced frame size when performing image shake correction, the present disclosure provides an image processing method, an electronic device, and a computer-readable storage medium, which can improve the clarity of the image and increase the frame size of the image when performing image shake correction.

FIG. 2 illustrates a flowchart of an image processing method according to an embodiment of the present disclosure, which may begin at block 210:

At block 210, a first image captured by a first camera and a second image captured by a second camera are obtained, wherein the first camera and the second camera have different fields of view.

At block 220, a fused image is generated based on the first image and the second image.

At block 230, an output image is generated by performing image shake correction on the fused image.

In the image processing method provided by an embodiment of the present disclosure, by fusing images captured by two cameras with different fields of view, an image with a larger frame size can make up for the loss of the frame size of an image as compared to the smaller frame size that results when performing image shake correction conventionally, thereby maximizing the preservation of the frame size of image. And, image fusion can improve the clarity of the image. For example, in the case when the first camera has a larger field of view and the second camera has a higher resolution, the image clarity can be improved while reducing the loss of the image frame size, so as to achieve a better anti-shake effect and improve user's shooting experience.

The image processing method according to the embodiment of the present disclosure will be introduced in more detail below.

At block 210, a first image captured by a first camera and a second image captured by a second camera are obtained.

The method corresponding to the described embodiment of the present disclosure may be performed by a video capture device, for example, a smart phone, a tablet computer, a camera, etc. The video capture device may be configured with two cameras, or may be configured with more cameras. Here, an example video capture device may comprise two cameras (for example, a first camera and a second camera). The first camera and the second camera can simultaneously capture the same content to generate the first image and the second image respectively. As alluded to above, the first camera and the second camera have different fields of view.

Optionally, the first camera may be a first camera may be a wide-angle camera providing a field of view of the first camera that is greater than the field of view of the second camera, a. The wide-angle camera may have a shorter focal length and a larger field of view, and can capture a wide range of scenes at a relatively close distance. Of course, in order to make the field of view of the first camera as large as possible, the first camera may also be an ultra-wide-angle camera. In order to improve the clarity of the second image, the second camera may be a high-definition camera. Conversely, when the field of view of the second camera is larger than that of the first camera, the second camera may be a wide-angle camera or an ultra-wide-angle camera, and the first camera may be a high-definition camera. A wide-angle camera can be a device with a lower photosensitive area or resolution than a high-definition camera. The present disclosure takes an example in which the field of view of the first camera is larger than the field of view of the second camera.

At block 220, a fused image is generated based on the first image and the second image.

In the embodiment of the present disclosure, when the field of view of the first camera is larger than the field of view of the second camera, after the first image and the second image are fused, the field of view will increase relative to the second image. In this way, when image shake correction is performed on the fused image, the loss of the field of view can be mitigated.

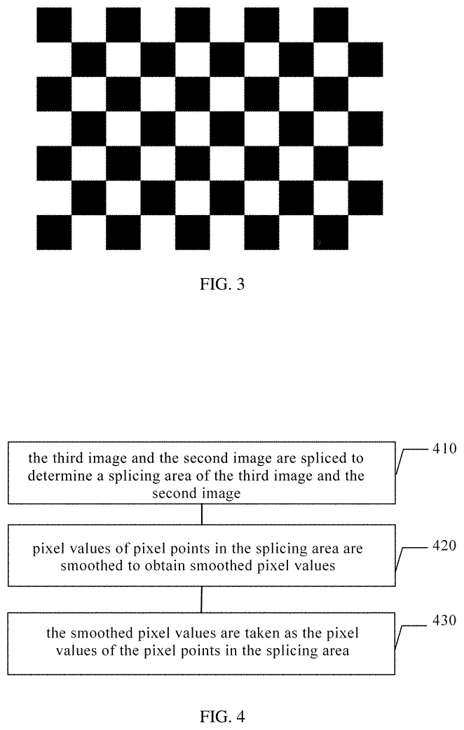

It should be understood that the larger the field of view of the camera, the more the captured image is prone to distortion. Then, for the first image captured by the first camera with a larger field of view, distortion correction and image scaling may be sequentially performed to obtain a third image. Specifically, distortion calibration can be performed on the first camera first. The image distortion includes radial distortion and tangential distortion. The distortion coefficient can be obtained from the captured checkerboard image. See FIG. 3 for a schematic diagram of the checkerboard calibration.

Among them, the mathematical model of radial distortion is:

u′=u(l+k₁r²+k₂r⁴+k₃r⁶),

v′=v(l+k₁r²+k₂r⁴+k₃r⁶)

and the mathematical model of tangential distortion is:

u″=u+[2p₁^{v}+p₂(r²+2u²)],

v″=v+[p₁(r²+2v²)+2p₂u)]

In accordance with these models/formulas, r²=u²+v², (u, v) is the ideal coordinate, (u′,v′) is the coordinate after radial distortion, (u″,v″) is the coordinate after tangential distortion. The values of the distortion parameters k1, k2, k3, p1, and p2 can be obtained through checkerboard calibration.

After that, (u₁, v₁) corresponding to (u₀, v₀) can be calculated according to the following distortion correction formula:

$$\{ \begin{matrix}{x}_{1} = ( {u}_{0} - cx ) / fx \\ {y}_{1} = ( {v}_{0} - cy ) / fy \\ {r}^{2} = {x}_{1}^{2} + {y}_{1}^{2} \\ {x}_{2} = {x}_{1} ( 1 + {k}_{1} {r}^{2} + {k}_{2} {r}^{4} ) + 2 {p}_{1} {x}_{1} {y}_{1} + {p}_{2} ( {r}^{2} + 2 {x}_{1}^{2} ) \\ {y}_{2} = {y}_{1} ( 1 + {k}_{1} {r}^{2} + {k}_{2} {r}^{4} ) + {p}_{1} ( {r}^{2} + 2 {y}_{1}^{2} ) + 2 {p}_{2} {x}_{1} {y}_{1} \\ {u}_{1} = fx * x 2 + cx \\ {v}_{1} = fy * y 2 + cy\end{matrix} ,$$

In accordance with these formulas, cx, cy, fx, fy are camera internal parameters, which can also be obtained by checkerboard calibration, (u₀, v₀) is the pixel coordinate after distortion correction, (u₁, v₁) is the pixel coordinate corresponding to (u₀, v₀) before distortion correction. The pixel value of the (u₁, v₁) coordinate point in the image before the distortion correction is sequentially filled into the (u₀, v₀) coordinate of the image after the distortion correction, and the image distortion correction process is completed.

After the distortion correction is performed on the first image, image scaling processing may be performed on the distortion corrected image according to the image scaling formula:

x′=x((p₁w₂)/p₂w₁)),

y′=y((p₁w₂)/(p₂w₁))

In accordance with these formulas, (x, y) is the pixel coordinate after scaling, (x, y) is the pixel coordinate before scaling, w₁ and p₁ represent the width of the physical size and the number of pixels in the horizontal direction of the effective photosensitive area of the image sensor in the first camera respectively, w₂ and p₂ represent the width of the physical size and the number of pixels in the horizontal direction of the effective photosensitive area of the image sensor in the second camera respectively.

Image scaling refers to a process of adjusting the size of an image, and image scaling in this embodiment of the present disclosure refers to scaling up an image, so that the scaled-up image (i.e., the third image) has the same pixel ratio as the second image, so that image stitching can be performed directly with the second image. When splicing the third image and the second image, a mapping relationship between the coordinates of the pixels in the second image and the coordinates of the pixels in the third image can be generated. According to the mapping relationship, the distortion correction formula and the image scaling formula, the third image and the second image can be fused to obtain a fused image. The generation process regarding the fused image can be seen in FIG. 4, which may begin at block 410:

At block 410, the third image and the second image are spliced to determine a splicing area of the third image and the second image.

Specifically, the Stitching module in Opencv (open source computer vision library) can be used to splice the third image and the second image, and the mapping relationship between the coordinates of the pixels in the second image and the coordinates of the pixels in the third image can be obtained. Among them, Opencv can implement many general algorithms in image processing and computer vision, for example, the Stitching module can implement image splicing, and so on.

At block 420, pixel values of pixel points in the splicing area are smoothed to obtain smoothed pixel values.

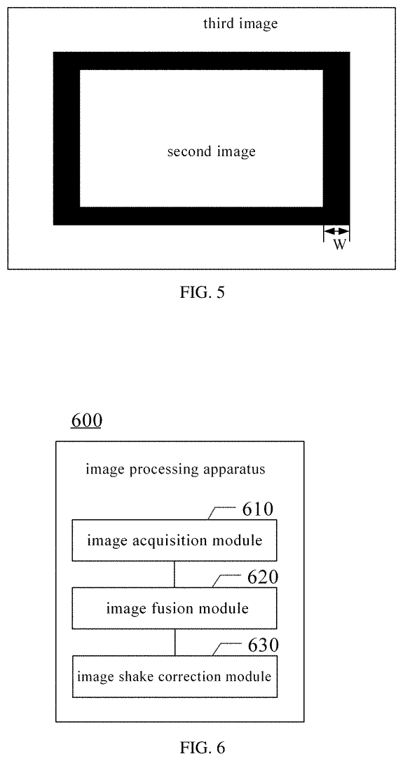

It can be understood that, since the field of view of the first camera is larger and the frame size of the first image is larger, then, after performing distortion correction and image scaling on the first image, the first image is enlarged, and the obtained splicing area of the third image and the second image is the outer circular area of the second image. FIG. 5 illustrates a schematic diagram of the splicing area of the third image and the second image. It can be seen that the third image can be used as the background, the second image can be used as the foreground, and the splicing area is the shadow area.

After image splicing, there is a certain brightness difference between the input third image and the second image, resulting in obvious light and dark changes at both sides of the spliced image seam line (that is, the outer ring line of the shadow area in FIG. 5). Therefore, the splicing area can be smoothed. Optionally, for any pixel point in the splicing area in the second image, a weighted average of the pixel value of that pixel point and a pixel value of a target pixel point corresponding to that pixel point in the third image can be performed to obtain a smoothed pixel value. Wherein, the pixel value of the pixel point in the second image can be obtained directly, and the pixel value of the target pixel point in the third image can be determined in the following way:

Firstly, the coordinates of the target pixel point are determined.

In the embodiment of the present disclosure, the coordinates of any pixel point in the splicing area in the second image can be obtained first, and the coordinates of the target pixel point can be determined according to those coordinates and a mapping relationship between coordinates obtained when the image is spliced previously.

Secondly, an initial pixel point in the first image corresponding to the target pixel point is determined based on the coordinates of the target pixel point.

In the embodiment of the present disclosure, since the target pixel point is a pixel point in the third image, and the third image is obtained by performing distortion correction and image scaling on the first image, therefore, according to the coordinates of the target pixel point, the initial pixel point in the first image corresponding to the target pixel point is obtained through the above-mentioned distortion correction formula and the image scaling formula.

Finally, the pixel value of the initial pixel point is taken as the pixel value of the target pixel point.

Of course, in embodiments of the present disclosure, the coordinates of that pixel point can also be directly determined according to any pixel point in the splicing area in the third image, and the coordinates of corresponding pixel point in the second image can be determined according to the mapping relationship between the coordinates. The pixel value of that pixel point and the pixel value of the target pixel point corresponding to that pixel point in the second image are performed weighted average to obtain the smoothed pixel value.

The weighted average formula in the embodiment of the present disclosure may be: H=d×H_{W}+(1−d)×H_{M}, where d is an adjustable factor, 0≤d≤1, along the direction from the third image to the second image, d gradually changes from 1 to 0, H represents the smoothed pixel value, H_{W} represents the pixel value of the pixel point in the third image, and H_{M} represents the pixel value of the pixel point in the second image. Among them, the weighted smoothing algorithm can deal with the seam problem quickly and easily.

In an implementation of the present disclosure, in order to establish greater correlation between the pixel points in the image splicing area and the third image and the second image, can make: d=d1/(d1+d2), that is, the weighted average formula can also be:

$$H = \frac{{d}_{1}}{{d}_{1} + {d}_{2}} \times {H}_{W} + \frac{{d}_{2}}{{d}_{1} + {d}_{2}} \times {H}_{M} ,$$

and through weighted average of this formula, the pixel value of each pixel point in the splicing area can be calculated.

In accordance with these formulas, d1+d2=w, where w represents the width of the splicing area, if the splicing is left and right splicing. Variables d1 and d2 represent the distances from a pixel point in the splicing area to the left and right boundaries of the splicing area. If the splicing is up and down splicing, then d1 and d2 represent the distances from the a pixel point in the splicing area to the upper and lower boundaries of the splicing area, respectively. For example, the shadow area (i.e., the splicing area) in FIG. 5 can be divided into four areas: top, bottom, left and right. The left area and the right area are left and right splicing, and the upper area and the lower area are up and down splicing.

At block 430, the smoothed pixel values are taken as the pixel values of the pixel points in the splicing area.

It should be noted that for the non-splicing area within the splicing area, the pixel value of the pixel point in the area may be the pixel value of the pixel point in the second image. For the non-splicing area outside the splicing area, the pixel value of the pixel point in the area may be the pixel value of the pixel point in the third image. Thus far, the pixel values of the pixel points in all regions can be determined, and, the fused image can be generated.

At block 230, an output image is obtained/generated by performing image shake correction on the fused image.

In an embodiment of the present disclosure, image shake correction can be performed on the fused image using an electronic image stabilization algorithm. Specifically, the angular velocity of motion of the three axes of a video capture device can be detected in real-time through the gyroscope, and reverse compensation can be performed on the edge cropping area to stabilize the picture pixel points within a certain range to achieve the effect of image stabilization. The larger the cropping area, the smaller the cropped image, the stronger the anti-shake ability, and the lower the image clarity and the smaller the frame size. Optionally, in the electronic image stabilization algorithm, after cropping the fused image, the frame size of the cropped image obtained is larger than or equal to the frame size of the second image. That is to say, when cropping the fused image, the cropping area can be the edge area of the third image, and the edge area of the third image is used by anti-shake compensation without cropping the area where the second image is located. Therefore, an image with a larger frame size than the second image can be obtained, thereby making up for the loss of the field of view and increasing the frame size of the image.

It can be understood that if the user shoots a video in a stable environment, the electronic image stabilization function does not need to be turned on. In this case, the image processing method of the embodiment of the present disclosure can provide a wide-angle ultra-high-definition video mode for the user, and the user can also obtain a video with a larger frame size and higher clarity, which can improve the user's shooting experience.

In the image processing method according to one embodiment of the present disclosure, two images with different fields of view are fused, so that an image with a larger field of view can compensate for the loss of field of view when an image with a smaller field of view is corrected for image shake thereby maximizing the preservation of the frame size of the image. In addition, image fusion can improve the clarity of the image, and by smoothing the splicing area of the fused image, the quality of the image can be improved. For example, when the first camera has a larger field of view than the second camera, but the second camera has a higher resolution than that of the first camera, despite the first camera having a lower resolution, the edge resolution of the image is only slightly lower than that of the main frame size when the video capture device is shaken. However, users are generally insensitive to edge area of images. Therefore, the present disclosure can improve image clarity while reducing the loss of image frame size, thereby achieving better anti-shake effect and improving a user's shooting experience.

It should be noted that although the various steps of the methods of the present disclosure are depicted in the figures in a particular order, this does not require or imply that the steps must be performed in that particular order, or that all illustrated steps must be performed to achieve the desired result. Additionally, or alternatively, certain steps may be omitted, multiple steps may be combined into one step for execution, and/or one step may be decomposed into multiple steps for execution, and the like.

Further, in the exemplary embodiment of the present disclosure, an image processing apparatus 600 is also provided, as shown in FIG. 6, which includes the following.

An image acquisition module 610, which is configured to obtain a first image captured by a first camera and a second image captured by a second camera respectively, wherein the first camera and the second camera have different field of view.

An image fusion module 620, which is configured to generate a fused image based on the first image and the second image.

An image shake correction module 630, which is configured to obtain an output image by performing image shake correction on the fused image.

Optionally, the image fusion module includes the follows.

A preprocessing unit, which is configured to obtain a third image by performing distortion correction and image scaling processing on the first image in sequence, wherein the field of view of the first camera is larger than the field of view of the second camera; and

A fusion unit, which is configured to obtain the fused image by fusing the third image and the second image.

Optionally, the fusion unit is specifically configured to splice the third image and the second image to determine a splicing area of the third image and the second image; to smooth pixel values of pixel points in the splicing area to obtain smoothed pixel values; and to take the smoothed pixel values as the pixel values of the pixel points in the splicing area.

Optionally, the fusion unit smooths pixel values of the pixel points in the splicing area to obtain the smoothed pixel values through the following way:

For any pixel point in the splicing area in the second image, a weighted average of the pixel value of that pixel point and a pixel value of a target pixel point corresponding to that pixel point in the third image is performed to obtain a smoothed pixel value.

Optionally, the fusion unit is further configured to determine the coordinates of the target pixel point; to determine an initial pixel point in the first image corresponding to the target pixel point based on the coordinates of the target pixel point; and to take the pixel value of the initial pixel point as the pixel value of the target pixel point.

Optionally, the image shake correction module is configured to perform image shake correction on the fused image through an electronic image stabilization algorithm.

Optionally, in the electronic image stabilization algorithm, after cropping the fused image, the frame size of the cropped image obtained is greater than or equal to the frame size of the second image.

The specific details of each module or unit in the above-mentioned apparatus have been described in detail in the corresponding image processing method, so they will not be repeated here.

It should be noted that although several modules or units of the apparatus for action performance are mentioned in the above detailed description, this division is not mandatory. Indeed, according to embodiments of the present disclosure, the features and functions of two or more modules or units described above may be embodied in one module or unit. Conversely, the features and functions of one module or unit described above may be further divided into multiple modules or units to be embodied.

In an exemplary embodiment of the present disclosure, an electronic device is also provided, which includes: a first camera for capturing a first image; a second camera for capturing a second image, wherein the first camera and the second camera has different field of view; a processor; a memory for storing processor-executable instructions; wherein the processor is configured to perform all or part of the steps of the image processing method in this exemplary embodiment.

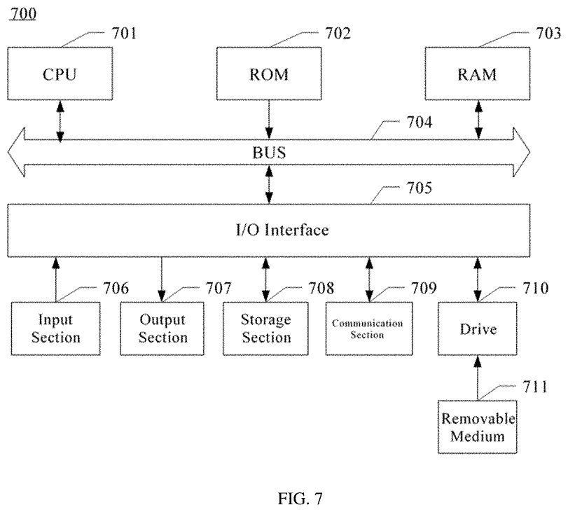

FIG. 7 illustrates a schematic structural diagram of a computer system for implementing an electronic device according to an embodiment of the present disclosure, e.g., image processing apparatus 600 or any of the component modules making up image processing apparatus 600. It should be noted that the computer system 700 of the electronic device shown in FIG. 7 is only an example, and should not impose any limitations on the functions and scope of use of the embodiments of the present disclosure.

As shown in FIG. 7, a computer system 700 includes a central processing unit (CPU) 701 which can perform various appropriate actions and processes according to a program stored in a read only memory (ROM) 702 or a program loaded into a random-access memory (RAM) 703 from a storage section 708. In the RAM 703, various programs and data necessary for system operation are also stored. The CPU 701, the ROM 702, and the RAM 703 are connected to each other through a bus 704. An input/output (I/O) interface 705 is also connected to bus 704.

The following components are connected to the I/O interface 705: an input section 706 including a keyboard, a mouse, a first camera and a second camera, etc.; an output section 707 including a cathode ray tube (CRT), a liquid crystal display (LCD), etc., and a speaker, etc.; a storage section 708 including a hard disk, etc.; and a communication section 709 including a network interface card such as a local area network (LAN) card, a modem, and the like. The communication section 709 performs communication processing via a network such as the Internet. A drive 710 is also connected to the I/O interface 705 as needed. A removable medium 711, such as a magnetic disk, an optical disk, a magneto-optical disk, a semiconductor memory, etc., is mounted on the drive 710 as needed so that a computer program read therefrom is installed into the storage section 708 as needed.

In particular, according to embodiments of the present disclosure, the processes described above with reference to the flowcharts may be implemented as computer software programs. For example, embodiments of the present disclosure include a computer program product comprising a computer program carried on a computer-readable medium, the computer program containing program code for performing the method illustrated in the flowchart. In such an embodiment, the computer program may be downloaded and installed from the network via the communication portion 709 and/or installed from the removable medium 711. When the computer program is executed by the central processing unit (CPU) 701, various functions defined in the apparatus of the present disclosure are executed.

In an exemplary embodiment of the present disclosure, there is also provided a computer-readable storage medium on which a computer program is stored, and when the computer program is executed by a processor, implements any one of the methods described above.

It should be noted that the non-transitory computer-readable storage medium shown in the present disclosure may be, for example, but not limited to, an electrical, magnetic, optical, electromagnetic, infrared, or semiconductor system, apparatus or device, or any combination of the above. More specific examples of computer-readable storage medium may include, but are not limited to, electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In this disclosure, a computer-readable storage medium may be any tangible medium that contains or stores a program that can be used by or in conjunction with an instruction execution system, apparatus, or device. In the present disclosure, however, a computer-readable signal medium may include a data signal propagated in baseband or as part of a carrier, carrying computer-readable program code therein. Such propagated data signals may take a variety of forms, including but not limited to electromagnetic signals, optical signals, or any suitable combination of the foregoing. A computer-readable signal medium can also be any computer-readable medium other than a computer-readable storage medium that can transmit, propagate, or transport the program for use by or in conjunction with the instruction execution system, apparatus, or device. Program code embodied on a computer-readable medium may be transmitted using any suitable medium including, but not limited to, wireless, wireline, optical fiber cable, radio frequency, etc., or any suitable combination of the foregoing.

Other embodiments of the present disclosure will readily occur to those skilled in the art upon consideration of the specification and practice of the disclosure disclosed herein. This disclosure is intended to cover any variations, uses, or adaptations of the present disclosure, and these variations, uses, or adaptations follow the general principles of this disclosure and include common knowledge or conventional techniques in the art not disclosed in this disclosure. The specification and embodiments are to be regarded as exemplary only, with the true scope and spirit of the disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

What is claimed is:

1. An image processing method, comprising:
obtaining a first image and a second image captured by a first camera and a second camera respectively, wherein the first camera and the second camera have different fields of view;
generating a fused image based on the first image and the second image; and
obtaining an output image by performing image shake correction on the fused image.

2. The method as claimed in claim 1, wherein generating a fused image based on the first image and the second image comprises:
obtaining a third image by performing distortion correction and image scaling processing on the first image in sequence, wherein the field of view of the first camera is larger than the field of view of the second camera; and
obtaining the fused image by fusing the third image and the second image.

3. The method as claimed in claim 2, wherein obtaining the fused image by fusing the third image and the second image comprises:
splicing the third image and the second image to determine a splicing area of the third image and the second image;
smoothing pixel values of pixel points in the splicing area to obtain smoothed pixel values; and
taking the smoothed pixel values as the pixel values of the pixel points in the splicing area.

4. The method as claimed in claim 3, wherein the method further comprises:
determining, based on the second image, pixel values of non-splicing area enclosed by the splicing area, and
determining, based on the third image, pixel values of non-splicing area outside the splicing area.

5. The method as claimed in claim 3, wherein smoothing pixel values of pixel points in the splicing area to obtain smoothed pixel values comprises:
performing, for any pixel point in the splicing area in the second image, a weighted average of the pixel value of that pixel point and a pixel value of a target pixel point corresponding to that pixel point in the third image to obtain a smoothed pixel value.

6. The method as claimed in claim 5, wherein the pixel value of the target pixel point corresponding to that pixel point in the third image is determined by:
determining the coordinates of the target pixel point;
determining an initial pixel point in the first image corresponding to the target pixel point based on the coordinates of the target pixel point; and
taking the pixel value of the initial pixel point as the pixel value of the target pixel point.

7. The method as claimed in claim 5, wherein performing a weighted average of the pixel value of that pixel point and a pixel value of a target pixel point corresponding to that pixel point in the third image comprises:
determining the weight corresponding to the pixel value of the target pixel point based on the coordinates of that pixel point in the splicing area; and
performing a weighted average of the pixel value of that pixel point and the pixel value of the target pixel point based on the weight corresponding to the pixel value of the target pixel point.

8. The method as claimed in claim 1, wherein performing image shake correction on the fused image comprises:
performing image shake correction on the fused image through an electronic image stabilization algorithm.

9. The method as claimed in claim 8, wherein in the electronic image stabilization algorithm, after cropping the fused image, the frame size of the cropped image obtained is greater than or equal to the frame size of the second image.

10. An electronic device, comprising:
a first camera, configured to capture a first image;
a second camera, configured to capture a second image;
a processor; and
a memory, configured to store executable instructions for the processor;
wherein, the processor is configured to execute the executable instructions to:
obtain a first image captured by a first camera and a second image captured by a second camera, wherein the first camera and the second camera have different fields of view;
generate a fused image based on the first image and the second image; and
obtain an output image by performing image shake correction on the fused image.

11. The electronic device as claimed in claim 10, wherein generate a fused image based on the first image and the second image comprises:
obtain a third image by performing distortion correction and image scaling processing on the first image in sequence, wherein the field of view of the first camera is larger than the field of view of the second camera; and
obtain the fused image by fusing the third image and the second image.

12. The electronic device as claimed in claim 11, wherein obtain the fused image by fusing the third image and the second image comprises:
splice the third image and the second image to determine a splicing area of the third image and the second image;
smooth pixel values of pixel points in the splicing area to obtain smoothed pixel values; and
take the smoothed pixel values as the pixel values of the pixel points in the splicing area.

13. The electronic device as claimed in claim 12, wherein the processor is further configured to execute the executable instructions to:
determine, based on the second image, pixel values of non-splicing area enclosed by the splicing area, and
determine, based on the third image, pixel values of non-splicing area outside the splicing area.

14. The electronic device as claimed in claim 12, wherein smooth pixel values of pixel points in the splicing area to obtain smoothed pixel values comprises:
perform, for any pixel point in the splicing area in the second image, a weighted average of the pixel value of that pixel point and a pixel value of a target pixel point corresponding to that pixel point in the third image to obtain a smoothed pixel value.

15. The electronic device as claimed in claim 14, wherein determine the pixel value of the target pixel point corresponding to that pixel point in the third image comprises:
determine the coordinates of the target pixel point;
determine an initial pixel point in the first image corresponding to the target pixel point based on the coordinates of the target pixel point; and
take the pixel value of the initial pixel point as the pixel value of the target pixel point.

16. The electronic device as claimed in claim 14, wherein perform a weighted average of the pixel value of that pixel point and a pixel value of a target pixel point corresponding to that pixel point in the third image comprises:
determine the weight corresponding to the pixel value of the target pixel point based on the coordinates of that pixel point in the splicing area; and
perform a weighted average of the pixel value of that pixel point and the pixel value of the target pixel point based on the weight corresponding to the pixel value of the target pixel point.

17. The electronic device as claimed in claim 10, wherein perform image shake correction on the fused image comprises:
perform image shake correction on the fused image through an electronic image stabilization algorithm.

18. The electronic device as claimed in claim 17, wherein in the electronic image stabilization algorithm, after cropping the fused image, the frame size of the cropped image obtained is greater than or equal to the frame size of the second image.

19. A non-transitory computer-readable storage medium having stored therein instructions that, when executed by a processor, cause the processor to:
obtain a first image captured by a first camera and a second image captured by a second camera respectively, wherein the first camera has a larger field of view than the second camera and the second camera has a higher resolution than the first camera;
generate a fused image based on the first image and the second image; and
obtain an output image by performing image shake correction on the fused image.

20. The non-transitory computer-readable storage medium as claimed in claim 19, wherein generate a fused image based on the first image and the second image comprises:
obtain a third image by performing distortion correction and image scaling processing on the first image in sequence, wherein the field of view of the first camera is larger than the field of view of the second camera; and
obtain the fused image by fusing the third image and the second image.
